(19) United States
(12) Patent Application Publication
(10) Pub. No.: US 2007/0039036 A1
(43) Pub. Date: Feb. 15, 2007

(54) System, method and user interface to deliver message content

(75) Inventors: Marc A. Sullivan, Austin, TX (US); Philip T. Kortum, Houston, TX (US); Kurt M. Joseph, Austin, TX (US); Theodore Pasquale, Austin, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno, NV (US)

(21) Appl. No.: 11/203,437

(22) Filed: Aug. 12, 2005

(51) Int. Cl. H04N 7/173; H04N 7/16

(52) U.S. Cl. 725/133; 725/100; 725/131; 725/141; 725/153

(57) ABSTRACT

The present disclosure is directed to a system and method of delivering message content to a television monitor. The method includes merging a first electronic signal with a second electronic signal. The first electronic signal transmits recorded message content. The second electronic signal includes video content. The method may also include communicating the merged signal to a television monitor. The method can also include displaying the television content and content of the recorded message at the television monitor.

### FIELD OF THE DISCLOSURE

The present disclosure relates generally to delivery of message content.

### BACKGROUND

Recorded messages are a common part of daily life. An individual can reduce the time required to reach an unavailable person by recording one or more messages and submitting them to a message store. The unavailable person can then retrieve their messages from the message store at a later time. Often, messages can even replace person-to-person contact. Recorded messages include a variety of formats, such as voice messages and e-mail messages.

Television viewing is also part of daily life. Many individuals prefer not be interrupted while watching television, but they may desire to monitor recorded messages, for example, in case of an emergency or to avoid reviewing a large number of new messages at a future time. Nonetheless, the integration of messaging with television viewing is uncommon. Systems that allow a user to access a store of messages from a television typically interrupt television programming. Moreover, these systems provide, at most, message header information, such as the source or time of the message. This header information does not allow a user to monitor the actual content recorded by a sender of the message. Thus, users often cannot accurately assess—based on the limited header information—whether they should interrupt their television viewing and return a call or make other contact.

### BRIEF DESCRIPTION OF THE DRAWINGS

FIG. 1 is a block diagram illustrating an embodiment of a system over which messages can be sent and received;

FIG. 2 is a flow diagram illustrating a method of delivering message content to a television;

FIG. 3 is a flow diagram illustrating an alternative method of delivering message content to a television;

FIG. 4 is a diagram of a first embodiment of a user interface for accessing message content;

FIG. 5 is a diagram of a second embodiment of a user interface for accessing message content;

FIG. 6 is a diagram of a third embodiment of a user interface for accessing message content;

FIG. 7 is a diagram of an embodiment of a transport control device; and

FIG. 8 is a diagram of an illustrative embodiment of a general computer system.

### DETAILED DESCRIPTION OF THE DRAWINGS

The present disclosure is directed to a method of delivering message content to a television monitor. The method includes merging a first electronic signal with a second electronic signal. The first electronic signal transmits content recorded by one or more message senders. The second electronic signal transmits video content to be displayed at the television monitor. The method may also include communicating the merged signal to the television monitor. In a particular embodiment, the method can also include displaying the television content and the content of the message or messages at the television monitor.

Various aspects of the method may be implemented via a set-top box device. The set-top box may include a processor and a memory device accessible to the processor. A computer program is embedded within the memory device. The computer program includes instructions to merge a first electronic signal that transmits content recorded by one or more message senders, with a second electronic signal that transmits video content.

The present disclosure is also directed to a user interface to deliver message content. The user interface includes one or more television content regions, each of which display uninterrupted television programming. The user interface also includes a message content region that displays the content recorded by one or more message senders in a streamed format.

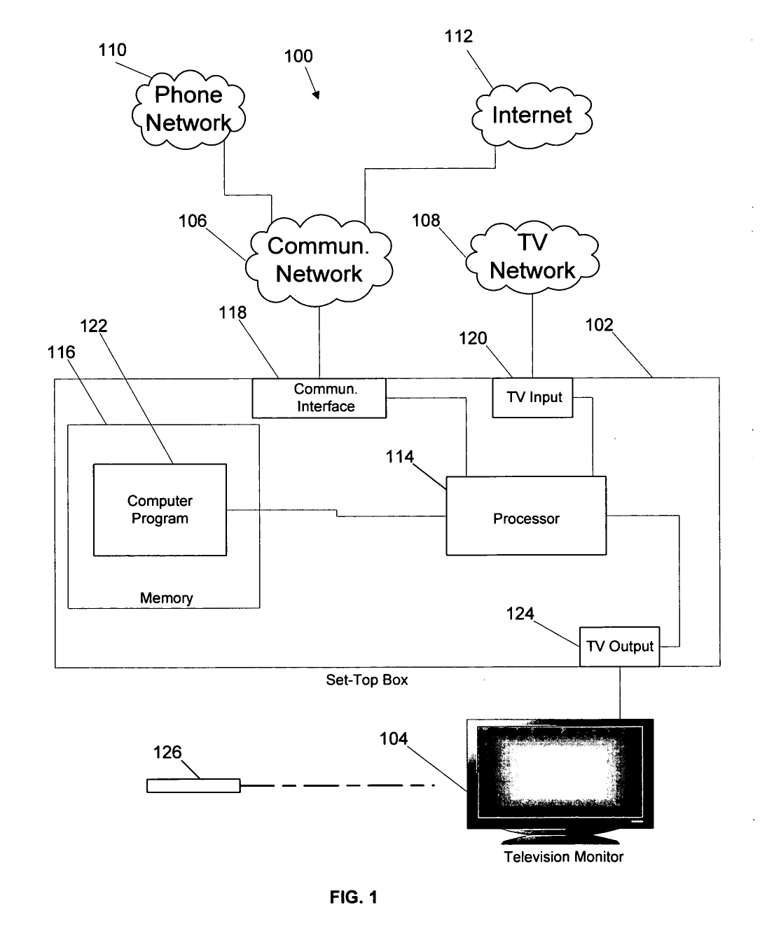

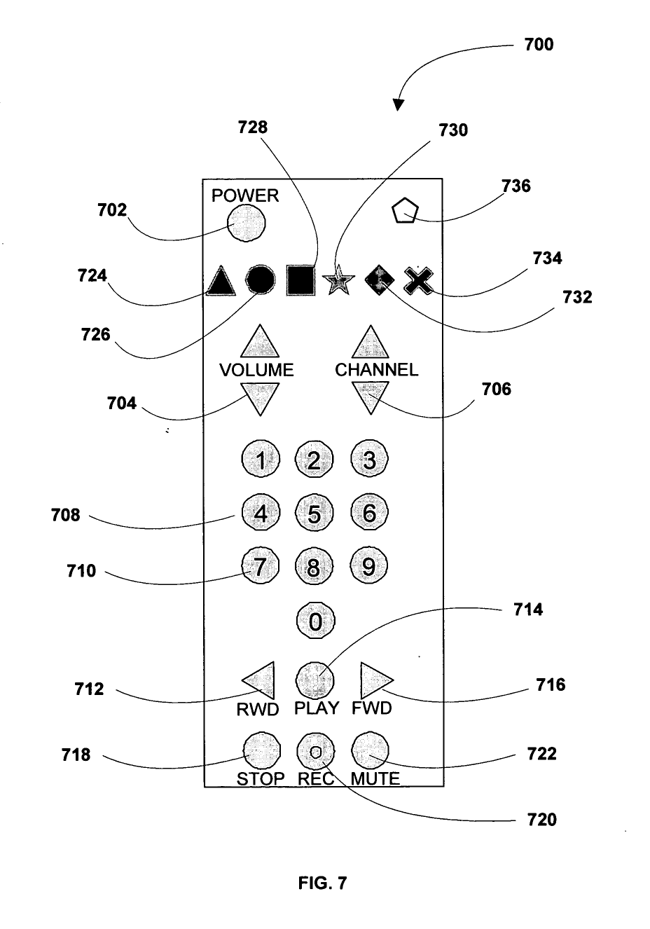

Referring to FIG. 1, a system is shown and is generally designated 100. As shown, the system 100 includes a set-top box device 102 that communicates with a television monitor 104. The television monitor 104 may include a television set, a monitor, or any other device suited to receive and display video and audio content. In a particular embodiment, the television monitor 104 communicates with a remote device 126 that allows a viewer to manipulate message content displayed at the television monitor. One embodiment of a remote device is further described with reference to FIG. 7.

As illustrated in FIG. 1, the set-top box device 102 can communicate with a communication network 106. The communication network 106 can be a broadband network, a cable network, a digital cable network, a digital subscriber line network, an internet protocol network, or any other network over which both audio and text data may be transmitted. FIG. 1 indicates that the set-top box device 102 can also communicate with a television network 108, which may include a cable network, a digital cable network, a satellite network, or any other network over which video content may be transmitted.

As shown in FIG. 1, the set-top box device 102 can include a processor 114 and a memory device 116 that is accessible to the processor 114. In a particular embodiment, the set-top box device 102 can receive messages from one or more phone networks 110 and one or more data networks 112, such as the Internet, via the communication network 106. The set-top box device may communicate with the communication network 106 through a communication interface 118. In a particular embodiment, the communication interface 118 can be any interface suited to facilitate communication between a set-top box device and one or more communication networks. For example, the communication interface 118 can facilitate communication between a set-top box device and a broadband network, a cable network, a digital cable network, a digital subscriber line network, an internet protocol network, or any other network over which both audio and text data may be transmitted.

In a particular embodiment, the set-top box device 102 can communicate with the television network 108 through a television input interface 120. Moreover, the television input interface 120 can be any interface that is suited to facilitate communication between a set-top box device and one or more television networks. For example, the television input interface can facilitate communication between a set-top box device and a cable network, a digital cable network, a satellite network, or any other network over which television content may be transmitted. In an illustrative embodiment, the television input interface 120 can include, for example, a coaxial cable connection, an optical cable connection, or an S-video input connection.

In a particular embodiment, the set-top box device 102 can communicate with the television monitor 104 through a television interface 124. The television interface 124 can be any interface that is suited to facilitate communication between a set-top box device and a display monitor. Such interfaces may include interfaces that facilitate communication between a set-top box device and a television set, a monitor, or any other device suited to receive and display television content. In an illustrative embodiment, the television interface 124 can include, for example, a coaxial cable connection, an optical cable connection, or an S-video output connection.

As illustrated in FIG. 1, a computer program 122, which is executable by the processor 114, can be embedded within the memory device 116. In a particular embodiment, the set-top box can include one or more additional computer programs that are embedded within the memory 116. In a particular embodiment, the computer program 122 can include instructions to merge a first electronic signal that transmits content recorded by the sender or senders of one or more messages, with a second electronic signal related to television content, thereby forming a merged signal. In a particular embodiment, the first electronic signal can be received over the communication network 106 via the communication interface 118, and the second electronic signal can be received over television network 108, via the television input interface 120. Designations of “first” and “second” signals are used only for convenience and do not indicate a sequence in which the two signals are received.

In a particular embodiment, the computer program 122 can also include instructions that can be executed to communicate the merged signal to the television monitor. In a particular embodiment, the computer program can also include instructions to display the message content transmitted by the first signal at the television monitor, along with the television content transmitted by the second signal, such that the display of message content does not interrupt television programming. In an illustrative embodiment, the message content can overlay the television content, e.g., as streaming text.

In a particular embodiment, at least one of the messages transmitted by the first signal can include a voice message. Further, the computer program 122 can also include instructions to convert each voice message to one or more text messages and to display the text message or text messages at the television monitor. The computer program 122 may also include instructions to broadcast the voice message or voice messages at the television monitor, as audio content. In a particular embodiment, the audio portion of the television content can be muted or decreased in volume, such that the user can hear each voice message, as the corresponding text message is displayed. In an illustrative embodiment, the broadcasting of each voice message as audio content may be selectable by a user.

In a particular embodiment, at least one of the messages transmitted by the first signal can include an e-mail message. Also, the computer program 122 can include instructions to display one or more e-mail messages at the television monitor. The computer program 122 may also include instructions to broadcast an audio version of the one or more e-mail messages at the television monitor. Additionally, the computer program 122 can include instructions to convert each e-mail message to one or more audio messages, and to broadcast one or more audio messages at the television monitor. In a particular embodiment, the audio portion of the television content can be muted or decreased in volume, such that the user can hear each audio message as the corresponding text message is displayed.

In a particular embodiment, the recorded voice or e-mail message can be recorded by another party and sent to the set-top box. In another particular embodiment, the computer program may also include instructions to record one or more voice messages from the sender or senders of each voice message. The computer program may also include instructions to receive one or more e-mail messages from the sender or senders of each e-mail message. Message display or playback can be controlled at the television monitor, via transport control commands transmitted to the set-top box from a remote control device. An illustrative embodiment of a remote control device is described further with reference to FIG. 7.

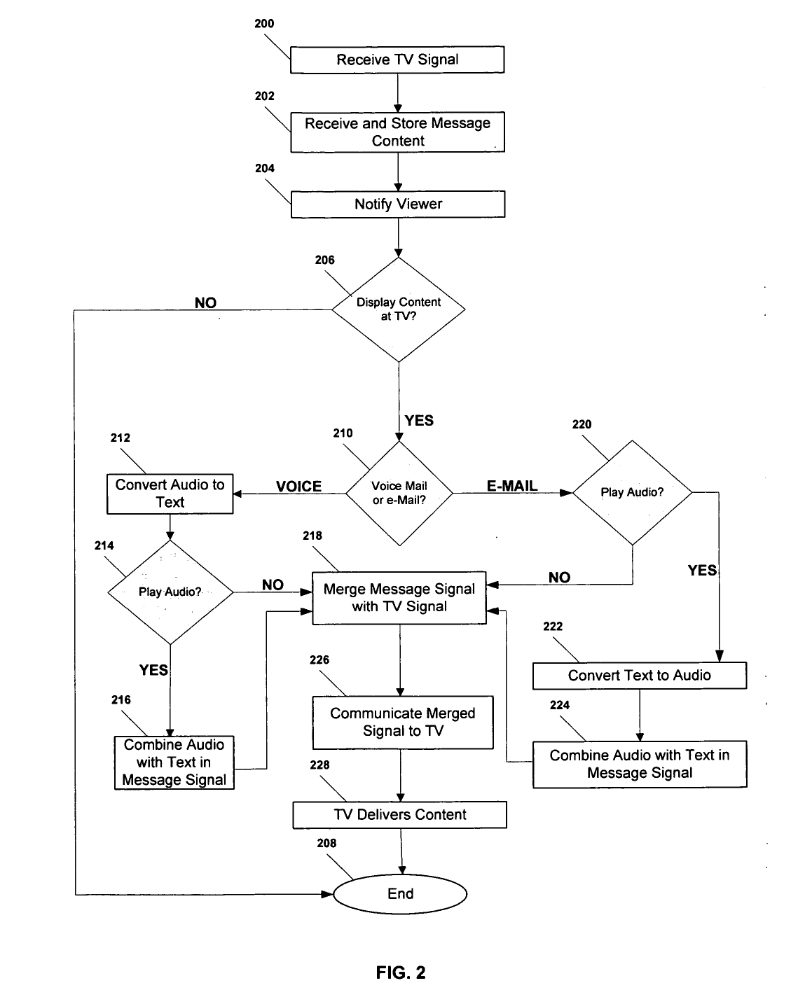

Referring to FIG. 2, a method of delivering message content to a television monitor is shown. At block 200, a television signal is received. At block 202, a message signal that transmits message content is received and stored. Message content includes the content recorded by a sender of a message. Message content may also include other information, such as a source, date, time, or subject of the message, as well as return information or other identifying indicia. For purposes of describing the method, blocks 200 and 202 are shown in succession. Nonetheless, such succession does not indicate that signals must be received in any sequence.

Moving to block 204, a viewer of the television monitor is notified that one or more messages have been received. In a particular embodiment, the notification may include a visual or audio notification, or both, at the television monitor. Further, the notification may also include a message tag that indicates whether each message is a voice or e-mail message. The notification can also include other information, such as source, date, time, or subject of the message, as well as return information or other identifying indicia. In an illustrative embodiment, the notification may include a pop-up screen or streaming text overlaying the concurrently displayed television program.

At decision step 206, the viewer is given the option to display the content recorded by the sender or senders of each message at the television monitor. If the viewer chooses not to display the content at the television monitor, the method ends at 208. If the viewer chooses to display the recorded message content at the television monitor, then the method proceeds to decision step 210. At decision step 210, it is determined whether each message that the viewer has chosen to display is a voice message or an e-mail message.

If a message is a voice message, the method proceeds to block 212, and the voice message is converted to a text message. Moving to decision step 214, the viewer is given the choice to broadcast the audio content of the voice message at the television monitor. If the viewer elects to broadcast the voice message, the method can proceed to block 216, and the audio content of the voice message is combined with the text message in the message signal. The method then proceeds to block 218, and the message signal is merged with the television signal.

Proceeding to block 226, the merged signal can be communicated to the television monitor. The method then proceeds to block 228, and the text message is displayed at the television monitor, while the voice message is also broadcast at the television monitor. The method ends at 208.

Returning to decision step 214, if the viewer elects not to hear the voice message at the television monitor, the method proceeds directly to block 218, and a signal containing the text message that was converted from the voice message is merged with the television signal. The method proceeds to block 226, and the merged signal can be communicated to the television monitor. The method proceeds to block 228, and the text message is displayed at the television monitor, and the method ends at 208.

In an illustrative embodiment, the text message may be streamed to the television monitor. For example, the text message may overlay other television content displayed at the television monitor. In this example, the text message may appear in a semi-transparent region, such that the television content can be seen through the message content region, with a low degree of viewing obstruction. In another example, the television content may be slightly re-sized, such that the text message streams across the lower or upper border of the television screen, in a manner similar to a news or stock ticker. In a particular embodiment, the position of the streaming text on the television monitor may be selectable by a user.

Returning to decision step 210, if a message that is to be displayed is an e-mail message, the method proceeds to decision step 220. At decision step 220, the viewer is given the choice to broadcast an audio version of the e-mail message at the television monitor. When the viewer elects to broadcast the e-mail message, the method can proceed to block 222, and the e-mail message is converted to an audio message. The method can proceed to block 224, and the audio message is combined with the e-mail message in the message signal. The method then proceeds to block 218, and the message signal is merged with the television signal. The method proceeds to block 226, and the merged signal can be communicated to the television monitor. The method then proceeds to block 228, and the e-mail message is displayed at the television monitor while the audio message that was converted from the e-mail message is broadcast at the television monitor. The method then ends at 208.

Returning to decision step 220, when the viewer elects not to hear an audio version of the e-mail message at the television monitor, the method proceeds directly to block 218, and a signal containing the e-mail message is merged with the television signal. In a particular embodiment, the method proceeds to block 226, and the merged signal can be communicated to the television monitor. The method then proceeds to block 228, and the e-mail message is displayed in text form at the television monitor. The method then ends at 208.

In an illustrative embodiment, the e-mail message may be streamed to the television monitor. For example, the e-mail message may overlay other television content displayed at the television monitor. In this example, the e-mail message may appear in a semi-transparent region, such that the television content can be seen through the message content region, with a low degree of viewing obstruction. In another example, the television content may be slightly re-sized, such that the e-mail message streams across the lower or upper border of the television screen, in a manner similar to a news or stock ticker. In a particular embodiment, the position of the streaming text on the television monitor may be selectable by a user.

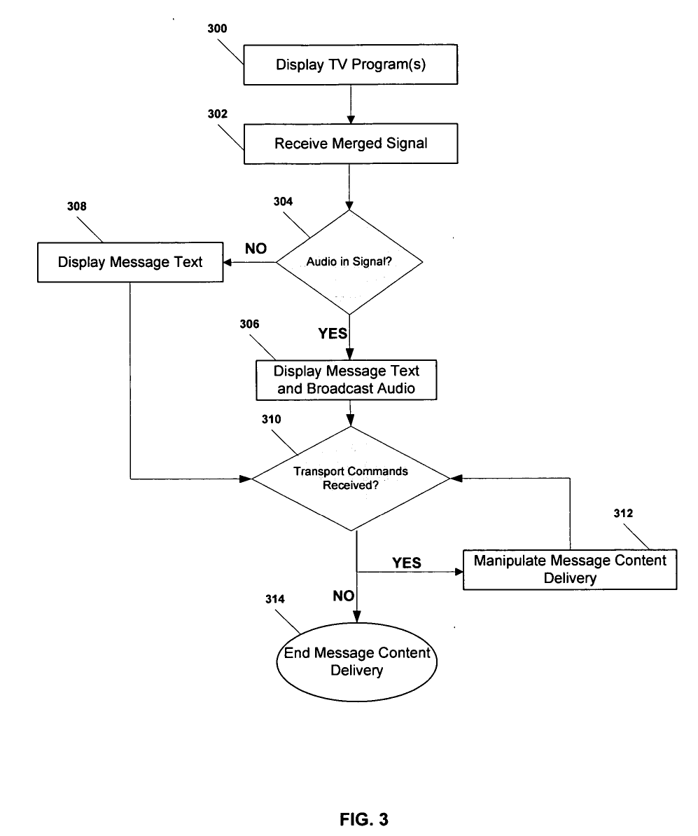

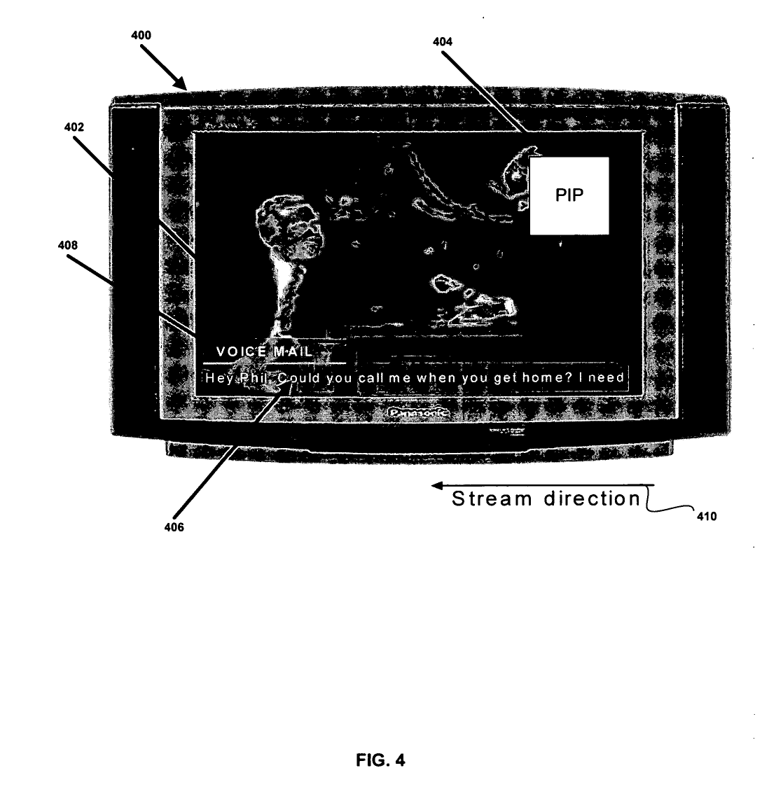

Referring to FIG. 3, an alternative method of delivering message content at a television monitor is shown. At block 300, television content is displayed at a television monitor. Multiple television programs may be displayed, for example, through Picture-in-Picture regions, as described with reference to FIG. 4. At block 302, a merged signal is received at the television monitor. The merged signal includes a television signal that transmits the television content and a message signal that transmits content recorded one or more message senders.

Proceeding to decision step 304, when audio content is not present in the merged signal, the method moves to block 308, and the content of the message is displayed as text. Conversely, when audio is present in the merged signal, the method continues to block 306. At block 306, the content of the message is displayed as text and is also broadcast as audio. In an exemplary embodiment, the text may comprise an e-mail message or a text version of a voice message. Also, the audio may comprise a voice message or an audio version of an e-mail message. In an illustrative embodiment, the text can be displayed as streaming text overlaying the television content.

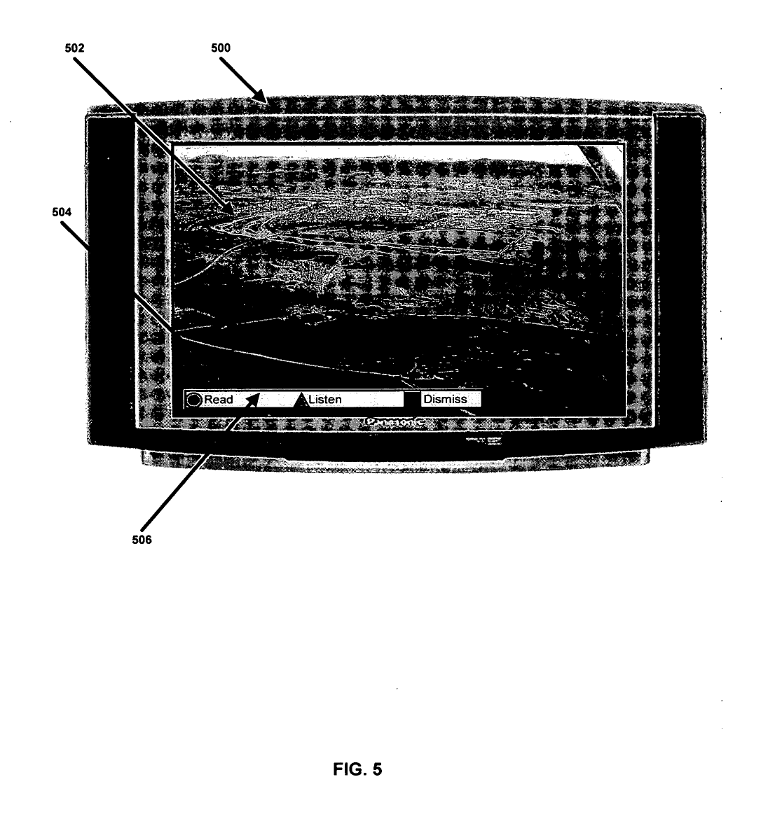

Moving to decision step 310, it is determined whether transport control commands are received. The text of the message that is displayed at the television monitor can be manipulated according to one or more transport control commands received from a remote control device or other source. Such transport control commands are described further with reference to FIGS. 5-7.

Transport control commands may include soft buttons on a user interface that are selectable by a user via a remote device. Examples of transport control commands include increasing a speed of a text stream, decreasing a speed of a text stream, reversing a direction of a text stream, pausing a text stream, ending a text stream, activating a text stream, and repeating a text stream. For purposes of describing the method, blocks 308 and 310 are shown in succession. Nonetheless, such succession does not indicate any sequence. The transport control commands can be received before, during or after a message or messages are displayed at the television monitor.

In this particular embodiment, if transport control commands are received, the method proceeds to block 312, and the delivery of the message or messages is manipulated, according to the particular command received. The method then returns to decision step 310 and it is determined whether additional transport control commands are received. If no transport control commands are received, or no additional transport control commands are received, the method ends at 314.

Referring to FIG. 4, a diagram of a first embodiment of a user interface to access message content is shown. The user interface can be provided on a television monitor 400. The user interface includes a primary display region 402 that displays television content. In a particular embodiment, the user interface may also include one or more secondary display regions 404, each of which displays additional television content. In an illustrative embodiment, a secondary display region 404 may include a Picture-in-Picture display.

As shown in FIG. 4, the user interface can also include a message content region 406 that can display content recorded by one or more message senders. In a particular embodiment, the content may include the text of an e-mail message, or a text message converted from a voice message. In an illustrative embodiment, the content is displayed as streaming text that overlays the television content in the primary display region 402. The streaming text may also overlay the television content in one or more secondary display regions 404. In a particular embodiment, a stream direction is from right to left, as indicated by arrow 410.

In this particular embodiment, the streaming text can be manipulated by one or more transport control commands that are issued from a remote device. In another embodiment, the transport control commands may be selected at the user interface, e.g., as soft buttons. Examples of transport control commands include increasing a speed of a text stream, decreasing a speed of a text stream, reversing a direction of a text stream, pausing a text stream, ending a text stream, activating a text stream, and repeating a text stream.

In a particular embodiment, the user interface also includes a tag region 408 that displays header information for each message displayed in the message content region 406. The tag region 408 may be part of the message content region and overlays the television content in the primary display region 402. The tag region 408 may also overlay the television content in one or more alternate display regions 404. In an illustrative embodiment, the header information may include indicators of the type of message being displayed, e.g., voice message or e-mail message. Moreover, the header information may also include other information, such as the source, date, time, or subject of the message, as well as return information or other identifying indicia.

In a particular embodiment, the television content displayed in the primary content region 402 and the alternate content regions 404 continues uninterrupted, while the message content is displayed in the message content region 406 and while any header information is displayed in the tag region 408.

Referring to FIG. 5, a diagram of a second embodiment of a user interface to deliver message content is shown. The user interface can be provided on a television monitor 500. The user interface includes a primary display region 502 that displays television content. The user interface also includes a message notification region 504 that displays notifications for one or more messages that have been received at a message store. In a particular embodiment, the notification may include source, date, time, or subject of the message, as well as return information or other identifying indicia.

In the illustrative embodiment shown by FIG. 5, the user interface can also include one or more action regions 506. Each action region can be displayed with a message notification. Each action region can include graphic displays of buttons that a user may press on a remote control device, in order to manipulate a message. For example, in the example depicted in FIG. 5, a user may press a remote control key shaped as, or labeled with, a circle, in order to read the message as text on the television monitor 500. In this example, the user may press a remote control key shaped as, or labeled with, a triangle, in order to listen to an audio version of the message. Likewise, in this example, the user may press a remote control key shaped as, or labeled with, a square, in order to deactivate the on-screen notification and save the message for another time.

In an illustrative embodiment, the television content displayed in the primary content region 502 and any alternate content regions continues uninterrupted, while the message notification is displayed in the message notification region 504 and while any action region 506 selectors are displayed.

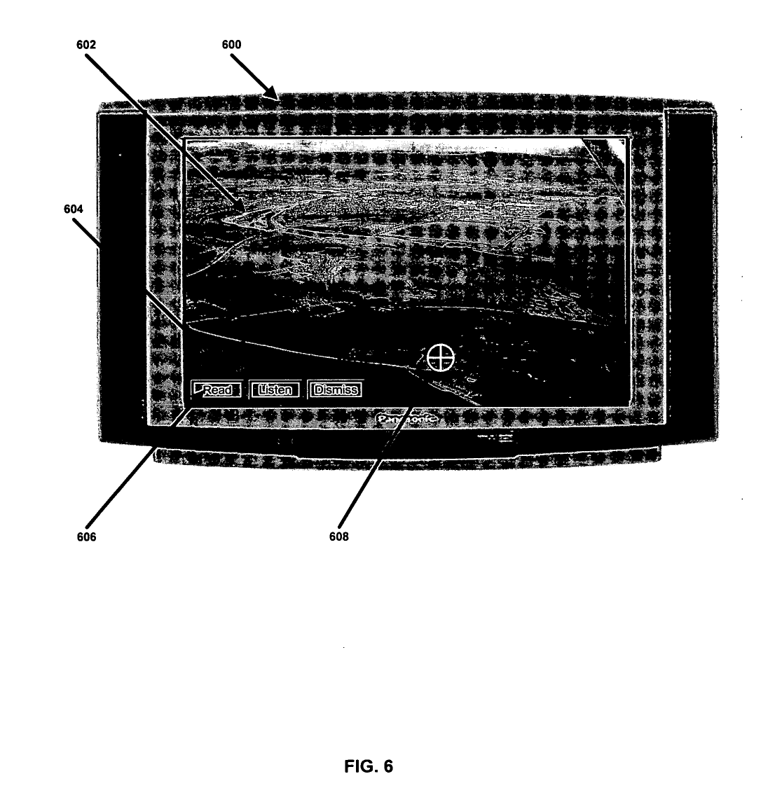

Referring to FIG. 6, a diagram of a third embodiment of a user interface to access message content is shown. The user interface can be provided on a television monitor 600. The user interface includes a primary display region 602 that displays television content. The user interface also includes a message notification region 604 that displays notifications for one or more messages that have been received at a message store. In a particular embodiment, the notification may include source, date, time, or subject of the message, as well as return information or other identifying indicia.

In the illustrative embodiment shown by FIG. 6, the user interface can also include one or more soft buttons 606. Each soft button 606 can be displayed with a message notification. Each soft button 606 can include a graphic representation of buttons that a user may select with a directional control. In an illustrative embodiment, a user may manipulate a pointer 608, using a remote control device, in order to select one or more soft buttons 606.

For example, in the illustration shown by FIG. 6, a user my select a soft button, in order to read the message as text on the television monitor 600. Also, the user may select a separate soft button, in order to listen to an audio version of the message. Further, in this example, the user may select a third soft button, in order to dismiss the on-screen notification and save the message for another time.

In a particular embodiment, the television content displayed in the primary content region 602 and any alternate content regions continues uninterrupted while the message notification is displayed in the message notification region 604 and while soft buttons 606 and the pointer 608 are displayed.

In conjunction with the configuration of structure described herein, the system, method and user interface provides television viewers with the ability to receive voice mail, e-mail or other messages, at a set-top box and review recorded content of such messages at a connected television monitor. Voice messages can be converted to text messages, and e-mail messages can be converted to audio messages. Message content can be displayed as streaming text that overlays television content without overly obstructing or interrupting the television content. Users may also opt to hear audio of the message content while text of the message content is displayed. The message content may be broadcast at the television monitor or at a speaker coupled to the set-top box. The user may manipulate message content that is displayed and broadcast using transport control commands issued by a remote control device.

Referring to FIG. 7, an illustrative embodiment of a remote control device is shown and is generally designated 700. As shown, the remote control device 700 includes a power button 702 that can be used to turn a set top box on and off. Moreover, the remote control device 700 includes two volume control buttons 704, e.g., a volume up button and a volume down button that can be used to control the volume of a television, via the set top box. As illustrated in FIG. 7, the remote control device 700 further includes a pair of channel control buttons 706, e.g., a channel up button and a channel down button, that can be used to move linearly, up or down, through the channels provided by the set top box.

FIG. 7 also indicates that the remote control device can include a numerical keypad 708 that includes ten buttons 710 numbered from zero to nine. The numerical keypad 708 can be used to input a channel number to the set top box. As further illustrated in FIG. 7, the remote control device 700 can include a rewind button 712, a play button 714, a forward button 716, a stop button 718, a record button 720, and a mute button 722. In an illustrative embodiment, these buttons 712, 714, 716, 718, 720, 722 can be used to control a digital video recorder (DVR), a digital video disc (DVD) player, or a video cassette recorder (VCR).

FIG. 7 further illustrates that the remote control device 700 can include a plurality of service buttons. Specifically, in a particular embodiment, the remote control device 700 can include a generally triangle-shaped button 724. Further, the remote control device 700 can include a generally circle-shaped second button 726. Also, in a particular embodiment, the remote control device 700 can include a generally square-shaped third button 728. Moreover, the remote control device 700 can include a generally star-shaped fourth button 730, a generally diamond-shaped fifth button 732, and a generally x-shaped sixth button 734.

As shown in FIG. 7, the service buttons 724, 726, 728, 730, 732, 734 on the remote control device 700 can be oriented in the same, or different, configuration as soft buttons on a user interface, such as that shown in FIG. 5. Moreover, each service button 724, 726, 728, 730, 732, 734 on the remote control device 700 can be the same color as the similarly shaped soft button on the user interface, such as that shown in FIG. 5. FIG. 7 further shows that the remote control device 700 includes a menu/display button 736 that can be pressed in order to cause a graphical user interface (GUI), e.g., one of the GUIs described herein, to be displayed at the television.

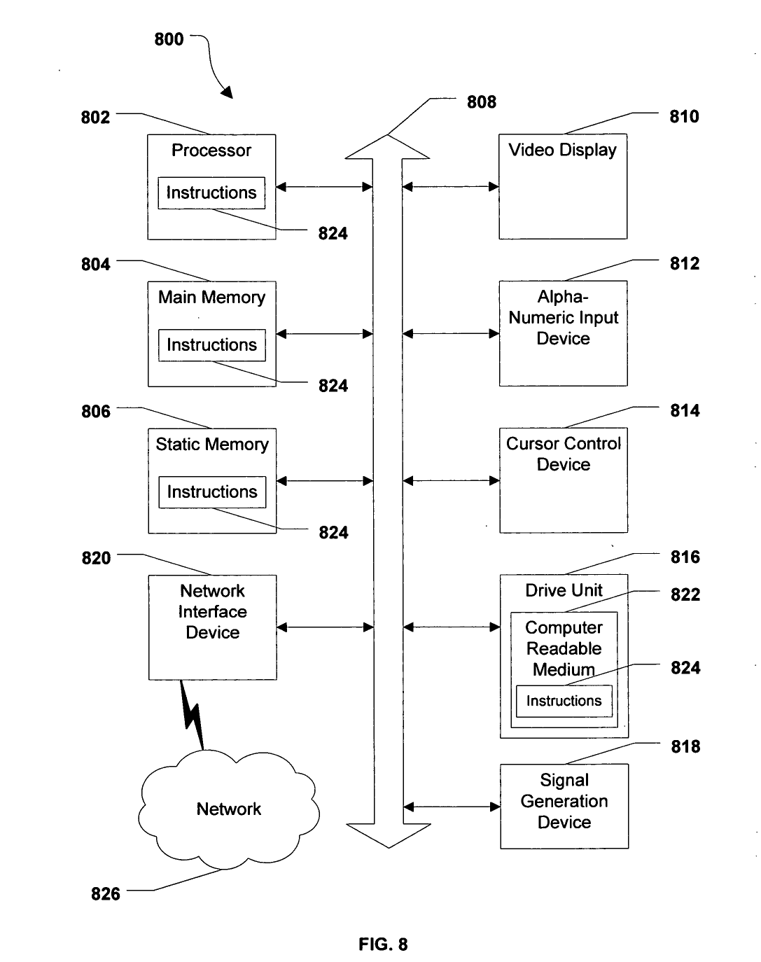

Referring to FIG. 8, an illustrative embodiment of a general computer system is shown and is designated 800. The computer system 800 can include a set of instructions that can be executed to cause the computer system 800 to perform any one or more of the methods or computer based functions disclosed herein. The computer system 800 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics processing unit (GPU), or both. Moreover, the computer system 800 can include a main memory 804 and a static memory 806, which can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. The computer system 800 can also include a disk drive unit 816, a signal generation device 818, such as a speaker or remote control, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal containing computer instructions. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of delivering message content to a television monitor, the method comprising:
merging a first electronic signal with a second electronic signal, wherein the first electronic signal and the second electronic signal together comprise a merged signal;
wherein the first electronic signal comprises at least one message that includes content recorded by a message sender; and
wherein the second electronic signal comprises video content to be displayed at the television monitor.

2. The method of claim 1, further comprising communicating the merged signal to the television monitor.

3. The method of claim 1, wherein the video content and content of the at least one message are displayed at the television monitor concurrently.

4. The method of claim 1, wherein the at least one message further comprises at least one voice message.

5. The method of claim 4, further comprising:
converting the at least one voice message to at least one text message; and
displaying the at least one text message at the television monitor.

6. The method of claim 5, wherein the at least one text message is streamed to the television monitor.

7. The method of claim 5, further comprising broadcasting the at least one voice message at the television monitor.

8. The method of claim 1, wherein the at least one message comprises at least one e-mail message and further comprising displaying the at least one e-mail message at the television monitor.

9. The method of claim 8, wherein the at least one e-mail message is streamed to the television monitor.

10. The method of claim 8, further comprising:
converting the at least one e-mail message to at least one audio message; and
broadcasting the at least one audio message at the television monitor.

11. A set-top box device, comprising:
a processor;
a memory device accessible to the processor; and
a computer program embedded within the memory device, the computer program comprising:
instructions to merge a first electronic signal representing a recorded text or audio message with a second electronic signal, wherein the first electronic signal and the second electronic signal together comprise a merged signal; and
wherein the second electronic signal comprises video content.

12. The set-top box of claim 11, wherein the computer program further comprises instructions to communicate the merged signal to a display monitor.

13. The set-top box device of claim 12, wherein the computer program further comprises instructions to display television content and content associated with the recorded message at the display monitor.

14. The set-top box device of claim 11, wherein the recorded message further comprises at least one voice message.

15. The set-top box device of claim 14, wherein the computer program further comprises:
instructions to convert the at least one voice message to at least one text message; and
instructions to display a text message corresponding to the at least one voice message at a television monitor.

16. The set-top box device of claim 14, wherein the computer program further comprises instructions to broadcast the at least one voice message at a speaker coupled to the set-top box.

17. The set-top box device of claim 12, wherein the computer program further comprises instructions to record at least one voice message from at least one message sender.

18. The set-top box device of claim 12, wherein:
the recorded message further comprises at least one e-mail message; and
wherein the computer program further comprises instructions to display the at least one e-mail message at a television monitor.

19. The set-top box device of claim 18, wherein the computer program further comprises:
instructions to convert the at least one e-mail message to at least one audio message; and
instructions to broadcast the at least one audio message at the television monitor.

20. The set-top box device of claim 11, wherein the computer program further comprises instructions to receive at least one e-mail message from at least one sender.

21. A user interface to deliver message content, the user interface comprising:
a television content region, wherein the television content region displays uninterrupted television programming;
a message content region, wherein the message content region displays at least one message in a streamed format; and
wherein the at least one message comprises content recorded by at least one message sender.

22. The user interface of claim 21, wherein the message content region at least partially overlays the at least one television content region.

23. The user interface of claim 21, wherein the message content region displays at least one text stream.

24. The user interface of claim 21, wherein the at least one text stream is responsive to at least one transport control command.

25. The user interface of claim 24, wherein the at least one transport control command is received from a remote control device.

26. The user interface of claim 24, wherein the at least one transport control command comprises at least one command chosen from a group consisting of increasing a speed of a text stream, decreasing a speed of a text stream, reversing a direction of a text stream, pausing a text stream, ending a text stream, activating a text stream, and repeating a text stream.

27. The user interface of claim 21, wherein the at least one message further comprises at least one voice message.

28. The user interface of claim 27, wherein:
the message content region displays at least one text message; and
wherein the at least one voice message has been converted into the at least one text message.

29. The user interface of claim 27, wherein:
the at least one message comprises at least one e-mail message; and
wherein the message content region displays the at least one e-mail message.

30. The method of claim 21, wherein the message content region displays at least one message notification.

31. The method of claim 21, wherein the message content region displays at least one message identifier.
